(19) United States
(12) Patent Application Publication
(10) Pub. No.: US 2025/0175365 A1
(43) Pub. Date: May 29, 2025

(54) AVIONICS COMMUNICATION NETWORK

(71) Applicant: SAFRAN ELECTRONICS & DEFENSE, PARIS (FR)

(72) Inventors: Patrice TOILLON, MOISSY-CRAMAYEL (FR); Abraham SUISSA, MOISSY-CRAMAYEL (FR); Thomas BENOIT, MOISSY-CRAMAYEL (FR); Thiebault JEANDON, MOISSY-CRAMAYEL (FR)

(21) Appl. No.: 18/719,510

(22) PCT Filed: Dec. 14, 2022
(86) PCT No.: PCT/EP2022/085930

§ 371 Date: Jun. 13, 2024

(30) Foreign Application Priority Data
Dec. 14, 2021 (FR) FR2113520

(51) Int. Cl. H04L 12/44; H04L 12/40

(52) U.S. Cl. CPC H04L 12/44; H04L 12/40; H04L 2012/4028; H04L 2012/445

(57) ABSTRACT

A communication network for connecting a plurality of electronic processing units to one another, the network having at least one switch which has at least one input port and one output port for connecting it to the electronic processing units and which is arranged to transmit a data frame of a data stream between at least two of the electronic processing units, the switch having at least one electronic circuit that is arranged to control a transit time of the data frame between the two electronic processing units.

### BACKGROUND OF THE INVENTION

### Field of the Invention

The invention relates to the field of communication networks and, in particular, avionics communication networks.

### Brief Description of the Related Art

In the aeronautical field, communication networks are used to support an aircraft's internal communications, i.e., the data exchanges between the various avionics elements of the aircraft (or within a given avionics element of the aircraft).

A communication network is used to connect a plurality of electronic processing units (for example, computers, processors, etc.) to one another. For this purpose, a communication network conventionally comprises a plurality of switches connected to one another and to the electronic processing units by data links (cables and/or wireless links, for example radio links). The switches exchange and monitor the data streams passing between the electronic processing units.

A data frame passing through a communication network, between a source electronic processing unit and a recipient electronic processing unit, is characterized, in particular, by its transit time through the communication network. The transit time (also referred to as latency) is therefore a key parameter for monitoring the ageing of the data frame passing through the communication network and, more particularly, the validity of this data when it is valid for a given maximum time period. The maximum value of the transit time of a data frame is conventionally predefined according to a worst-case scenario for a given network architecture, i.e., depending on the physical topology and the logical topology of the communication network in question. Furthermore, for certain types of data stream, explicit knowledge of the transit time of a data frame in the communication network is a key parameter enabling the recipient electronic processing unit (receiving the data frame) to compensate directly for the time delay affecting said data frame due to its propagation through the communication network. The time delay introduced by the communication network is thus known and taken into account at the receiver level, i.e., by the recipient electronic processing unit.

In the run-time phase of a communication network, the transit time of a data frame is conventionally measured as a unit. Indeed, each or only some of the switches of the communication network measure the unit latency of said data frame. The unit latency corresponds to the transit time of the data frame through the switch in question, i.e., the transit time of said data frame between an input port (at which said data frame is received) and an output port (from which the data frame is transmitted) of said switch. The measured value of the unit transit time is then compared to a unit transit time threshold (time quota) predefined during the design phase and also referred to as the design time. In this way, if the measured value of the unit transit time of a data frame is greater than the threshold, said data frame is considered obsolete. This prevents a switch from conveying a data frame that is too old.

The major disadvantage of the monitoring process described above is that it is fragmented (i.e., it does not provide an overall solution) because it is carried out locally by certain switches of the communication network. Proposals have thus been made to achieve overall control of the transit time of data frames through a communication network.

### SUMMARY OF THE INVENTION

One object of the invention is to propose a communication network enabling overall control of the transit time of data frames.

To this end, a communication network is proposed for connecting a plurality of electronic data processing units to one another, the network comprising at least one switch which has at least one input port and one output port for connecting it to the electronic processing units and which is arranged to transmit a data frame of a data stream between at least two of the electronic processing units. The switch comprises at least one electronic circuit that is arranged to control an overall transit time of the data frame between the two electronic processing units.

The invention is particularly advantageous because each switch of the communication network is arranged to enable the overall transit time of the data frame to be controlled. The data frame is therefore monitored on an overall basis, in this instance. This ensures that no obsolete data frame is transmitted to the electronic processing units.

In a first embodiment, the switch comprises a plurality of input ports and a plurality of output ports and the electronic circuit is arranged to:
measure a unit transit time of the data frame between a particular input port at which the data frame is received and a particular output port from which the data frame is transmitted; and
introduce, by concatenation, at the tail of the data frame, a data extension associated with the switch, the data extension comprising the measured unit transit time.

In the first embodiment, control of the overall transit time is achieved by a posteriori knowledge of the transit time, before the data frame is transmitted to the recipient electronic unit.

The network preferably comprises several switches connected to one another for transmitting the data frame between a head switch situated immediately downstream of the electronic processing unit transmitting the data frame and a tail switch situated immediately upstream of the electronic processing unit receiving the data frame, the electronic circuit of each switch being arranged to successively introduce the data extension at the tail of the data frame by concatenation.

Advantageously, the electronic circuit of the tail switch is arranged to extract the data extension associated with each switch by deconcatenation, the electronic circuit of the tail switch is arranged to sum the unit transit times and calculate the overall transit time of the data frame.

According to one particular feature, the electronic circuit of the tail switch is arranged to compare the overall transit time of the data frame to a predefined overall transit time threshold.

Preferably, the data extension associated with each switch respectively comprises an identifier of each switch, the electronic circuit of the tail switch is arranged to determine a transit path of the data frame between the head switch and the tail switch.

Advantageously, the data extension associated with each switch respectively comprises an identifier of the particular output port of each switch from which the data frame is transmitted.

Optionally, the electronic processing unit receiving the data frame is arranged to extract the data extension associated with each switch by deconcatenation, and the electronic processing unit receiving the data frame is arranged to sum the unit transit times and calculate the overall transit time of the data frame.

According to one particular feature, the electronic circuit of each switch upstream of the tail switch is arranged to successively introduce a piece of integrity data relating to the data extension by concatenation.

Advantageously, the integrity data is calculated at each switch.

As a variant, the integrity data is a piece of overall integrity data.

Optionally, the data frame comprises an additional field, all of the bits of which are at a predetermined logic level, one of the bits of the additional field being allocated to each of the switches and each switch being arranged to modify the bit of the additional field relating to said switch when the data frame passes through it.

In a second embodiment, first data streams configured to have priority over second data streams pass through the network and the electronic circuit comprises a memory in which there are defined a first FIFO queue dedicated to each output port of each switch for storing first data frames of the first data streams and a second FIFO queue dedicated to each output port of each switch for storing second data frames of the second data streams.

In the second embodiment, control of the overall transit time is based on the priority that is given to the data frames of the first stream. It is therefore known that the overall transit time is kept as short as possible and/or equal to a predefined value for a given physical transit path of a data frame.

Preferably, the electronic circuit is arranged so that the unit transit time of the first data frames of the first data streams is substantially fixed.

Also preferably, the electronic circuit is arranged so that the unit transit time of the second data frames of the second data streams has a variation less than a predefined variation threshold.

Optionally, priority levels are assigned to distinct data streams from among the first data streams and/or the second data streams, the electronic circuit is arranged so that the data frames of the distinct data streams are transmitted in ascending order of priority.

The invention also relates to a switch arranged to implement the communication network as previously described.

The invention also relates to an electronic architecture comprising a plurality of electronic processing units connected to one another by the communication network as previously described.

The invention also relates to an aircraft comprising such an electronic architecture.

Other features and advantages of the invention will become apparent on reading the following description of particular and non-limiting embodiments of the invention.

### BRIEF DESCRIPTION OF THE DRAWINGS

The description of the invention refers to the appended drawings in which:

FIG. 1 shows an aircraft comprising a communication network according to the invention;

FIG. 2 shows a structural view of the communication network shown in FIG. 1;

FIG. 3 shows the internal architecture of a switch of the communication network shown in FIG. 2 according to a first embodiment of the invention;

FIG. 4 shows a block definition diagram of the concatenation function of the switch shown in FIG. 3;

FIG. 5 shows a data frame according to a variant of the first embodiment of the invention;

FIG. 6 shows a data frame according to a variant of the first embodiment of the invention;

FIG. 7 shows the internal architecture of a switch of the communication network shown in FIG. 2 according to a second embodiment of the invention;

FIG. 8 shows a data stream identification and storage diagram according to a second embodiment of the invention.

### DETAILED DESCRIPTION OF THE INVENTION

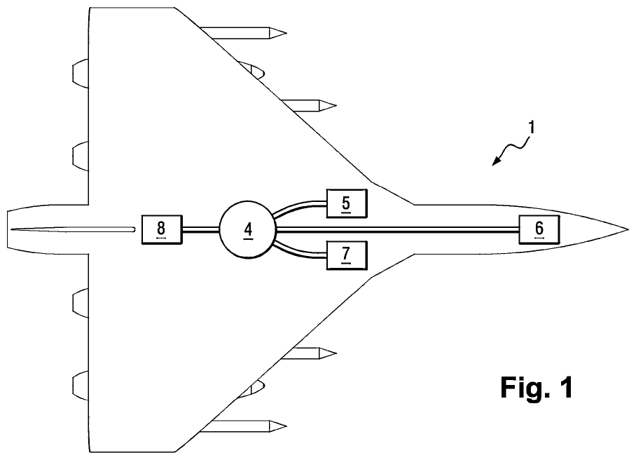

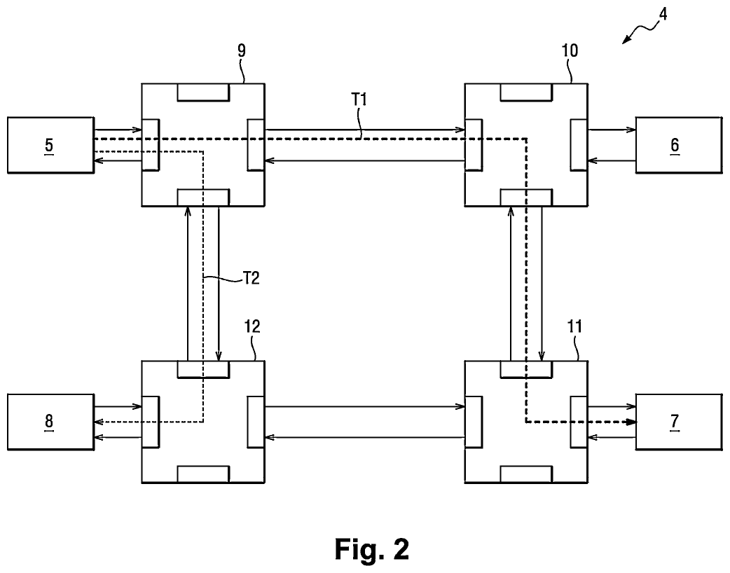

In reference to FIGS. 1 and 2, the communication network of the invention is in this instance described as applied to an aircraft generally denoted by reference number 1.

The aircraft 1 comprises avionics elements, i.e., electronic and computer equipment. Each of the avionics elements comprises one or more electronic processing units (computers, processors, etc.) connected to one another via a communication network 4. In this instance, the communication network 4 connects a first electronic processing unit 5, a second electronic processing unit 6, a third electronic processing unit 7 and a fourth electronic processing unit 8 to one another. The electronic processing units 5, 6, 7, 8 are in this instance electronic data processing units. The communication network 4 is in this instance an avionics communication network based on ARINC Specification 664, Part 7 (Avionics Full-Duplex Switched Ethernet) or an equivalent or derivative thereof.

The electronic processing units 5, 6, 7, 8 are in this instance compliant with ARINC Specification 664, Part 7 (End System) or an equivalent or derivative thereof. Furthermore, the electronic processing units 5, 6, 7, 8 may each belong to distinct avionics elements or may belong to the same avionics element.

In this instance, the communication network 4 comprises a first switch 9, a second switch 10, a third switch 11 and a fourth switch 12. The switches 9, 10, 11, 12 are in this instance compliant with ARINC Specification 664, Part 7 (Intermediate System) or an equivalent or derivative thereof.

The first switch 9 is connected to the first electronic processing unit 5, the second switch 10 is connected to the second electronic processing unit 6, the third switch 11 is connected to the third electronic processing unit 7 and the fourth switch 12 is connected to the fourth electronic processing unit 8.

Furthermore, the first switch 9 is connected to the second switch 10 and to the fourth switch 12 and the third switch 11 is connected to the second switch 10 and to the fourth switch 12. The switches 9, 10, 11, 12 are in this instance connected via an Ethernet connection (for example, via twisted pair cables connected to RJ45 connectors or indeed via cables with quadrax connectors specific to the aeronautical sector, or equivalent) and thus form a plurality of physical paths between the electronic processing units 5, 6, 7, 8.

The electronic processing units 5, 6, 7, 8 are arranged to exchange data streams. The data streams pass through the communication network 4 (i.e., via the switches 9, 10, 11, 12) in the form of data frames. The data frames pass through the communication network 4 using the Ethernet standard (IEEE 802.3 standard).

Also in reference to FIG. 2, a data stream T1 (represented by a long-dashed line) passes between the first electronic processing unit 5 and the third electronic processing unit 7, for example. The data stream T1 therefore passes via the first switch 9, the second switch 10 and the third switch 11. Moreover, a data stream T2 (short-dashed line) passes between the first electronic processing unit 5 and the fourth electronic processing unit 8, for example. The data stream T2 therefore passes via the first switch 9 and the fourth switch 12.

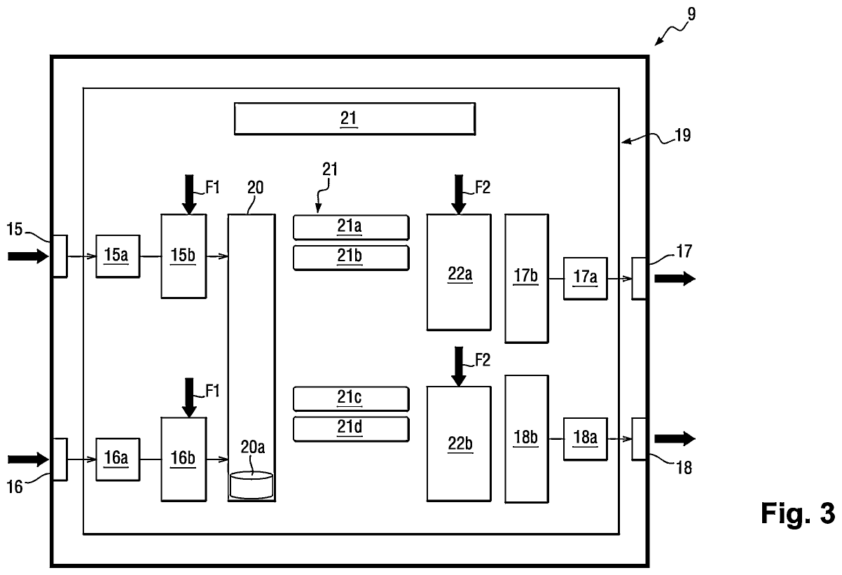

In reference to FIG. 3, the internal architecture of a particular switch of the communication network 4 is described. It should be understood that the internal architecture described here in reference to the first switch 9 also applies to each of the switches 9, 10, 11, 12 of the communication network 4.

The first switch 9 comprises two input ports, i.e., a first input port 15 and a second input port 16, and two output ports, i.e., a first output port 17 and a second output port 18. It should be noted that a port of the first switch 9 may simultaneously be an input port and an output port. In this instance, the first switch 9 comprises four ports which may be both input ports and output ports, depending on the path of the data frame in question.

The first switch 9 further comprises an electronic circuit 19 which comprises:
a first physical interface 15a and a first MAC (Medium Access Control) interface 15b dedicated to the first input port 15;
a second physical interface 16a and a second MAC interface 16b dedicated to the second input port 16;
a third physical interface 17a and a third MAC interface 17b dedicated to the first output port 17;
a fourth physical interface 18a and a fourth MAC interface 18b dedicated to the second output port 18;
a correspondence unit 20 comprising a static table 20a performing a function of configuring information and/or parameters for filtering, monitoring and broadcasting data frames;
a dating unit 21 performing a function of managing a local or current date;
a first control unit 22a dedicated to the first output port 17 (the first control unit 22a therefore supports a data frame output law);
a second control unit 22b dedicated to the second output port 18 (the second control unit 22b therefore supports the data frame output law);
a memory 21 in which there are defined a first FIFO (first-in-first-out) queue 21a, a second FIFO queue 21b, a third FIFO queue 21c and a fourth FIFO queue 21d.

The electronic circuit 19 is implemented, for example, by one or more electronic components (integrated components such as an FPGA (field-programmable gate array) or an ASIC (application-specific integrated circuit) and/or discrete components) mounted and connected to one another on a PCB (printed circuit board).

The first physical interface 15a, the second physical interface 16a, the third physical interface 17a and the fourth physical interface 18a operate in the physical layer defined by the OSI (Open Systems Interconnection) model.

The first MAC interface 15b, the second MAC interface 16b, the third MAC interface 17b and the fourth MAC interface 18b operate in the data link layer defined by the OSI model.

The physical interfaces 15a, 16a and the MAC interfaces 15b, 16b thus ensure that data frames are received by the first switch 9.

The physical interfaces 17a, 18a and the MAC interfaces 17b, 18b thus ensure that data frames are transmitted by the first switch 9.

The correspondence unit 20 uses the static table 20a to route the data frames received at the input ports 15, 16 to the memory 21 as a function of the destination MAC addresses included in said data frames. More specifically, the first FIFO queue 21a of the memory 21 is intended to store data frames received at the first input port 15 to be transmitted in the communication network 4 via the first output port 17. The second FIFO queue 21b of the memory 21 is intended to store data frames received at the second input port 16 to be transmitted in the communication network 4 via the first output port 17. The third FIFO queue 21c of the memory 21 is intended to store data frames received at the first input port 15 to be transmitted in the communication network 4 via the second output port 18. The fourth FIFO queue 21d of the memory 21 is intended to store data frames received at the second input port 16 to be transmitted in the communication network 4 via the second output port 18.

The dating unit 21 is used to date the data frames passing via the first switch 9. The dating unit 21 thus provides an input date and an output date for each of the data frames passing via the first switch 9. More precisely, each data frame received at one of the input ports 15, 16 is associated with the input date at the first MAC interface 15b or the second MAC interface 16b (see arrow F1 in FIG. 3). Furthermore, the first control unit 22a or the second control unit 22b acquires the output date of each data frame (arrow F2 in FIG. 3). The control unit 22a and the control unit 22b of the electronic circuit 19 can therefore measure a unit transit time of each data frame (between one of the input ports 15, 16 and one of the output ports 17, 18) passing via the first switch 9.

For example, a data frame received at the second input port 16 is associated with the input date at the second MAC interface 16b. Said data frame is then, for example, stored in the FIFO queue 21b of the memory 21 to be transmitted in the communication network 4 via the first output port 17. The control unit 22a acquires the output date of said data frame (see arrow F2 in FIG. 3). The control unit 22a thus measures the unit transit time of said data frame between the second input port 16 and the first output port 17.

Furthermore, the control unit 22a and the control unit 22b of the electronic circuit 19 can compare the measured unit transit time of each data frame to a unit transit time threshold predefined in the design phase of the communication network 4.

The electronic circuit 19 of the first switch 9 is thus arranged to locally monitor the ageing of each data frame. This is therefore the approach of the prior art, which considers only the unit transit time (i.e., not the overall transit time) of the data frames.

It should be noted that the internal architecture that has just been described is that of the first switch 9 but it applies to any switch of the communication network according to the invention 4.

According to the invention, the electronic circuit 19 of each of the switches 9, 10, 11, 12 of the communication network 4 is arranged to control an overall transit time of the data frames passing through said communication network 4 between at least two of the electronic processing units 5, 6, 7, 8.

According to a first embodiment of the invention, the electronic circuit 19 of each of the switches 9, 10, 11, 12 of the communication network 4 is arranged to introduce a data extension at the tail of each data frame (passing through the communication network 4). The data extension is therefore added to the tail of each data frame. For example, if a data frame passes through the communication network 4 via the first switch 9, the electronic circuit 19 of the first switch 9 is arranged to introduce the data extension relating to it at the tail of said data frame. Furthermore, the data extension is introduced at the tail of each data frame by concatenation (i.e., in the trailer of each data frame). The electronic circuit 19 of each of the switches 9, 10, 11, 12 of the communication network 4 is therefore arranged to perform a concatenation function.

The data extension of a data frame passing via a specific one of the switches 9, 10, 11, 12 comprises the unit transit time of said data frame between one of the input ports 15, 16 of said specific switch (at which said data frame is received) and one of the output ports 17, 18 of said specific switch (via which said data frame is transmitted).

Furthermore, it is provided that the data extension of the data frame passing via the specific switch comprises a physical unit transit time which corresponds to the transit time of said data frame through the physical interfaces of the specific switch. The transit time on the links between the switches is in this instance ignored because it is considered to be low compared to the transit time in the switches. However, it should be noted that, if the cables are long or when the communication network in question functions with a high throughput, the physical unit transit time is no longer negligible. The physical unit transit time for each of the input and output ports of the specific switch can be predetermined as a function of the physical topology of the communication network 4 (in the design phase, the physical unit transit time will then be a configurable parameter for each of the input and output ports of the specific switch); otherwise, it can be measured (either when the communication network 4 is put into operation, or continuously) using a far end loopback approach.

When the data frame passes through the communication network 4 (between at least two of the electronic processing units 5, 6, 7, 8) via several switches (from among the switches 9, 10, 11, 12), a head switch and a tail switch are defined. The head switch is one of the switches 9, 10, 11, 12 situated immediately downstream of the electronic processing unit transmitting the data frame. The tail switch is one of the switches 9, 10, 11, 12 situated immediately upstream of the electronic processing unit receiving the data frame.

According to the first embodiment of the invention, the electronic circuit 19 of each switch of the communication network 4 upstream of the tail switch is arranged to successively introduce the data extension relating to it at the tail of the data frame, by concatenation.

When the data frame is received at one of the input ports 15, 16 of the tail switch, said data frame therefore comprises the data extension relating to each switch of the communication network 4 upstream of said tail switch. The tail switch therefore receives a larger data frame.

The data stream T1 of FIG. 2 can be considered by way of example. The data stream T1 passes between the first electronic processing unit 5 and the third electronic processing unit 7 via the first switch 9, the second switch 10 and the third switch 11. For a data frame of the data stream T1, the head switch is the first switch 9 and the tail switch is the third switch 11. Therefore, when the data frame is received by the third switch 11 (which is the tail switch for the data frame of the data stream T1), said data frame successively comprises the data extension relating to the first switch 9 and the data extension relating to the second switch 10.

According to the first embodiment of the invention, the electronic circuit 19 of the tail switch is arranged to extract the data extension relating to each of the switches (upstream of said tail switch) via which the data frame has passed, by deconcatenation. The electronic circuit 19 of each of the switches 9, 10, 11, 12 therefore performs a deconcatenation function when it is the tail switch.

The electronic circuit 19 of the tail switch is thus arranged to acquire the unit transit times of the data frame measured by each of the switches (upstream of said tail switch).

Furthermore, the electronic circuit 19 of the tail switch is arranged to sum the measured unit transit times (including within itself) and thus calculate the overall transit time of the data frame in the communication network 4 (between at least two of the electronic processing units 5, 6, 7, 8). The electronic circuit 19 of each of the switches 9, 10, 11, 12 therefore performs a calculation function.

Furthermore, the electronic circuit 19 of the tail switch is arranged to compare the overall transit time of the data frame to an overall transit time threshold predefined in the design phase of the communication network 4. The electronic circuit 19 of each of the switches 9, 10, 11, 12 of the communication network 4 therefore performs a comparison function when it is a tail switch.

For example, for a data frame of the data stream T1, the electronic circuit 19 of the third switch 11 (i.e., the tail switch) determines the unit transit time in the switch 11 and extracts the unit transit time measured by the first switch 9 and the unit transit time measured by the second switch 10, by deconcatenation. The third switch 11 then calculates the overall transit time of the data frame and compares it to the predefined overall transit time threshold.

Each of the switches 9, 10, 11, 12 of the communication network 4 is thus arranged to monitor the overall ageing of each data frame passing through the communication network 4. This ensures that no obsolete data frame is transmitted to the electronic processing units 5, 6, 7, 8.

In a first variant of the first embodiment, the data extension of a data frame passing via a specific switch (from among the switches 9, 10, 11, 12) comprises, in addition to the unit transit time, an identifier of said specific switch.

When the data frame passes through the communication network 4 (between at least two of the electronic processing units 5, 6, 7, 8) via several switches (from among the switches 9, 10, 11, 12), the electronic circuit 19 of the tail switch is arranged to determine a transit path of the data frame between the head switch and the tail switch.

In a second variant of the first embodiment, the data extension of a data frame passing via a specific switch (from among the switches 9, 10, 11, 12) comprises, in addition to the unit transit time and the identifier, an identifier of one of the output ports of said specific switch via which the data frame is transmitted.

The concatenation, deconcatenation, calculation and comparison functions of the electronic circuit 19 of each of the switches 9, 10, 11, 12 described previously are implemented for each of the output ports 17, 18 of said switches 9, 10, 11, 12. More precisely, the concatenation, deconcatenation, calculation and comparison functions are implemented at each of the control units 22a, 22b.

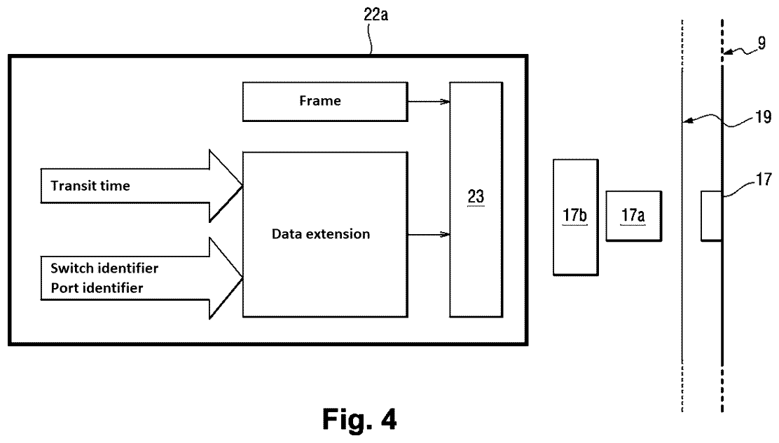

In reference to FIG. 4, the first output port 17 of the first switch 9 is considered in this instance. The control unit 22a dedicated to the first output port 17 comprises a concatenation unit 23 used to introduce the data extension relating to the first switch 9 at the tail of the data frame.

For example, the concatenation, deconcatenation, calculation and comparison functions of the electronic circuit 19 (of each of the switches 9, 10, 11, 12) are implemented in the form of hardwired logic in an FPGA (field-programmable gate array).

According to a third variant of the first embodiment of the invention, the data frame passes through the communication network 4 between a source electronic processing unit and a recipient electronic processing unit (from among the electronic processing units 5, 6, 7, 8) via several switches (from among the switches 9, 10, 11, 12), the head switch is situated immediately downstream of the electronic processing unit transmitting the data frame. The tail switch is situated immediately upstream of the electronic processing unit receiving the data frame.

The electronic circuit 19 of each switch of the communication network 4 and also of the tail switch is arranged to successively introduce the data extension relating to it at the tail of the data frame, by concatenation. It is therefore the electronic processing unit receiving the data frame that is arranged to extract, par deconcatenation, the data extension relating to each of the switches (therefore, including the tail switch) via which the data frame has passed. The electronic processing unit therefore performs the deconcatenation function.

The recipient electronic processing unit is thus arranged to acquire the unit transit times of the data frame measured by each of the switches via which said data frame has passed.

Furthermore, the electronic processing unit is arranged to sum the measured unit transit times and thus calculate the overall transit time of the data frame in the communication network 4 (i.e., the transit time of the data frame between the source electronic processing unit and the recipient electronic processing unit). The recipient electronic processing unit therefore performs the calculation function.

Furthermore, the recipient electronic processing unit is arranged to compare the overall transit time of the data frame to an overall transit time threshold predefined in the design phase of the communication network 4. The recipient electronic processing unit therefore performs the comparison function.

According to this third variant of the first embodiment, the electronic processing unit can thus itself determine whether or not a received data frame is valid.

Furthermore, when the data extensions associated with each of the switches (from among the switches 9, 10, 11, 12) comprise, in addition to the unit transit time, an identifier of said switches, the recipient electronic processing unit is preferably arranged to determine a transit path of the data frame between the source electronic processing unit and said recipient electronic processing unit.

The data stream T1 of FIG. 2 can be considered by way of example. The data stream T1 passes between the first electronic processing unit 5 and the third electronic processing unit 7 via the first switch 9, the second switch 10 and the third switch 11. When the data frame is received by the third electronic processing unit 7 (which is the recipient electronic processing unit for the data frame of the data stream T1), said data frame successively comprises the data extension relating to the first switch 9, the data extension relating to the second switch 10 and the data extension relating to the third switch 11 (which is the tail switch for the data frame of the data stream T1).

According to this third variant of the first embodiment, it is therefore provided that the electronic processing units 5, 6, 7, 8 are arranged to perform the deconcatenation, calculation and comparison functions. The deconcatenation, calculation and comparison functions may be supported directly by the End System of the recipient electronic processing unit or at the user level.

According to a fourth variant of the first embodiment, the electronic circuit 19 of each of the switches 9, 10, 11, 12 is arranged to introduce, into the data frame, a piece of integrity data relating to the data extension associated with it. More precisely, the integrity data is added to the tail of each data frame.

Preferably, the integrity data is an FCS (frame check sequence) error detection code calculated via a CRC (cyclic redundancy check) algorithm.

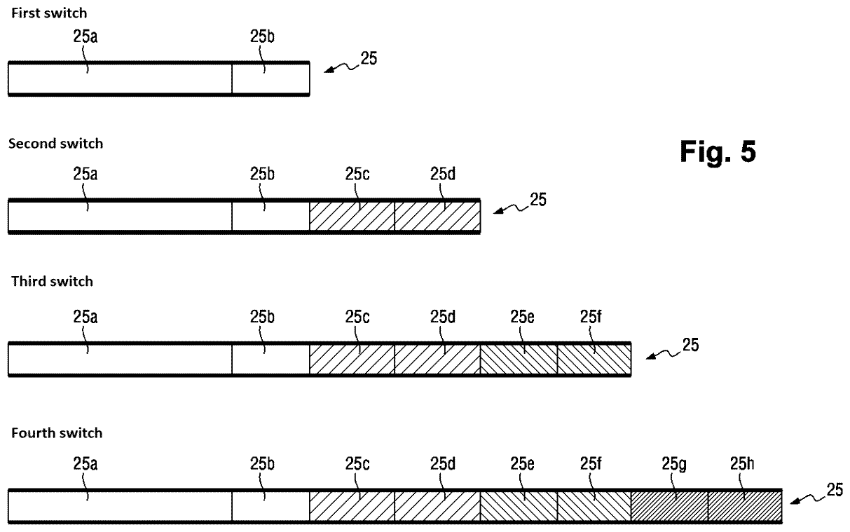

FIG. 5 shows a data frame 25 as it passes through the communication network 4. In this instance, the data frame 25 belongs, for example, to a data stream passing between the first electronic processing unit 5 and the fourth electronic processing unit 8 via the first switch 9, the second switch 10, the third switch 11 and the fourth switch 12.

When the first switch 9 (which is the head switch) receives the data frame 25, said data frame 25 comprises:
a first field 25a comprising a header and data to be transmitted; and
a second field 25b (for example with 32 bits) comprising a first piece of integrity data calculated by the electronic processing unit 5.

When the second switch 10 receives the data frame 25, said data frame 25 comprises the fields 25a, 25b and:
a third field 25c (for example with 32 bits) comprising the data extension relating to the first switch 9; and
a fourth field 25d (for example with 32 bits) comprising a second piece of integrity data calculated by the first switch 9 for the data frame 25 received by said first switch 9. The second piece of integrity data is calculated in order for the fields 25a, 25b, 25c, 25d inclusive.

When the third switch 11 receives the data frame 25, said data frame 25 comprises the fields 25a, 25b, 25c, 25d and:
a fifth field 25e (for example with 32 bits) comprising the data extension relating to the second switch 10; and
a sixth field 25f (for example with 32 bits) comprising a third piece of integrity data calculated by the second switch 10 for the data frame 25 received by said second switch 10. The third piece of integrity data is calculated in order for the fields 25a, 25b, 25c, 25d, 25e, 25f inclusive.

When the fourth switch 12 (which is the tail switch) receives the data frame 25, said data frame 25 comprises the fields 25a, 25b, 25c, 25d, 25e, 25f and:
a seventh field 25g (for example with 32 bits) comprising the data extension relating to the third switch 11; and
an eighth field 25h (for example with 32 bits) comprising a fourth piece of integrity data calculated by the third switch 11 for the data frame 25 received by said third switch 11. The fourth piece of integrity data is calculated in order for the fields 25a, 25b, 25c, 25d, 25e, 25f, 25g, 25h inclusive.

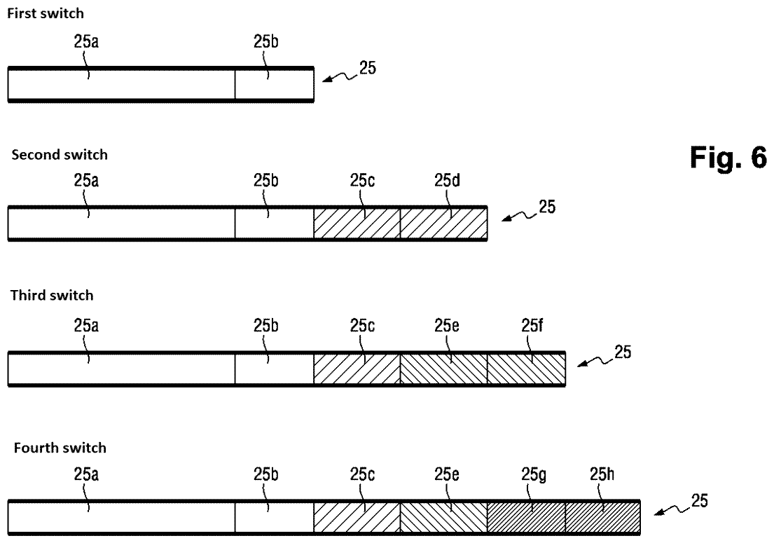

In reference to FIG. 6, a variant of the data frame 25 as it passes through the communication network 4 is shown.

When the first switch 9 (which is the head switch) receives the data frame 25, said data frame 25 comprises:
The first field 25a comprising a header and data to be transmitted; and
the second field 25b comprising the first piece of integrity data calculated by the electronic processing unit 5.

When the second switch 10 receives the data frame 25, said data frame 25 comprises the fields 25a, 25b and:
the third field 25c comprising the data extension relating to the first switch 9; and
the fourth field 25d comprising a second piece of integrity data calculated by the first switch 9 for the data frame 25 received by said first switch 9.

When the third switch 11 receives the data frame 25, said data frame 25 comprises the fields 25a, 25b, 25c and:
a fifth field 25e comprising the data extension relating to the second switch 10 which takes the place of the fourth field 25d; and
a sixth field 25f comprising a third piece of integrity data calculated by the second switch 10 for the data frame 25 received by said second switch 10.

When the fourth switch 12 (which is the tail switch) receives the data frame 25, said data frame 25 comprises the fields 25a, 25b, 25c, 25e and:
a seventh field 25g comprising the data extension relating to the third switch 11 which takes the place of the sixth field 25f; and
an eighth field 25h comprising a fourth piece of integrity data calculated by the third switch 11 for the data frame 25 received by said third switch 11.

When the data frame 25 is received by the fourth switch 12, said data frame comprises only the fourth piece of integrity data which is a piece of overall integrity data.

According to a fifth variant of the first embodiment, when the data frame is received (by the tail switch and/or the recipient electronic processing unit) said data frame comprises:
a first field comprising a header and data to be transmitted;
a second field (for example with 32 bits) comprising a first piece of integrity data calculated by the source electronic processing unit;
a third field (for example with 32 bits) comprising the overall transit time of the data frame. In this instance, the unit transit times of each switch through which the data frame has passed are therefore directly summed in the data frame; and
a fourth field (for example with 32 bits) comprising a second piece of integrity data which is recalculated at each switch through which the data frame has passed.

The number of fields introduced by concatenation at the tail of the data frame is thus advantageously limited.

According to a sixth variant of the first embodiment, the data frame comprises an additional field (for example with 32 bits), all of the bits of which are at a predetermined logic level, in this instance a low logic level bas (i.e., at ‘0’). The additional field of the data frame may be added directly by the source electronic processing unit transmitting said data frame or be added by the head switch processing said data frame. Each bit of the additional field relates to a particular switch of the communication network 4. For example, the first bit of the additional field relates to the first switch 9, the second bit of the additional field relates to the second switch 10, etc. When the data frame passes through the particular switch, this is arranged to modify the bit of the additional field relating to said particular switch (said particular switch could also rewrite the whole of the additional field to modify the bit that relates to it), in this instance changing it to a high logic level (i.e., to ‘1’). Therefore, when the data frame is received by the recipient electronic processing unit (or the tail switch corresponding to the data frame in question), it is thus possible to know the transit path of the data frame through the communication network (without the order in which it passes through the switches).

The data stream T1 of FIG. 2 can be considered by way of example. The data stream T1 passes between the first electronic processing unit 5 and the third electronic processing unit 7 via the first switch 9, the second switch 10 and the third switch 11. It is provided that the data frame transmitted by the first electronic processing unit 7 comprises a data field (for example comprising four useful bits, one for each of the switches 9, 10, 11, 12). The four useful bits of the additional field are initially equal to ‘0000’. When the data frame is received by the third electronic processing unit 7, the four useful bits of the additional field are equal to ‘1110’. It is possible to deduce that the data frame of the data stream T1 has passed through the first switch 9, the second switch 10 and the third switch 11 but not through the fourth switch 12.

It is also provided that the electronic circuit 19 of each of the switches 9, 10, 11, 12 is arranged to check that each data frame passing through the communication network 4 is compatible with the IEEE 802.3 standard.

A second embodiment is described below. The elements of this second embodiment that are identical or similar to those described above will have a reference number identical to the latter.

In the second embodiment of the invention, the communication network 4 ensures the transit of first data streams and of second data stream. Furthermore, the switches are configured to give the first data streams priority over the second data streams.

The priority of the first data streams over the second data streams is fixed in the design phase of the communication network 4.

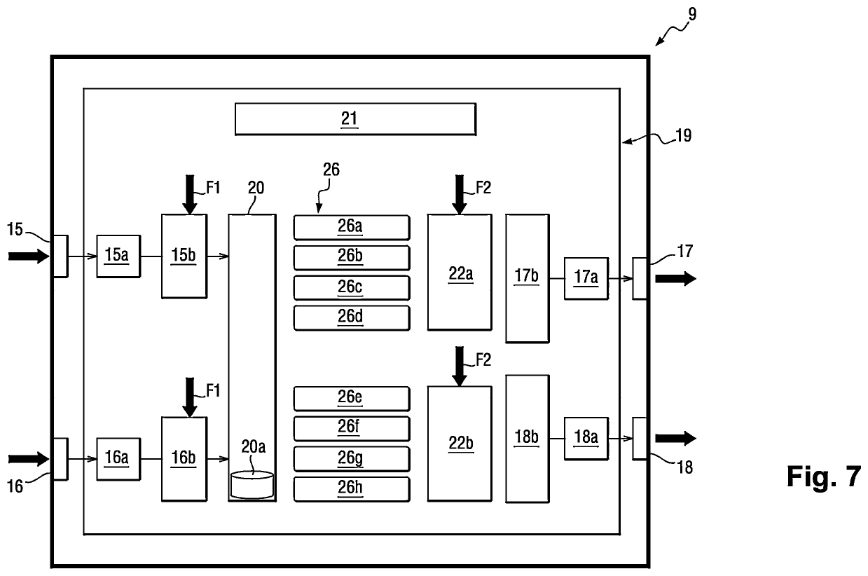

In reference to FIG. 7, the electronic circuit 19 of each of the switches 9, 10, 11, 12 comprises a memory 26 in which the following are defined:
A FIFO queue 26a intended to store data frames of the first data streams received at the first input port 15 to be transmitted in the communication network 4 via the first output port 17;
A FIFO queue 26b intended to store data frames of the second data streams received at the first input port 15 to be transmitted in the communication network 4 via the first output port 17;
A FIFO queue 26c intended to store data frames of the first data streams received at the second input port 16 to be transmitted in the communication network 4 via the first output port 17;
A FIFO queue 26d intended to store data frames of the second data streams received at the second input port 16 to be transmitted in the communication network 4 via the first output port 17;
A FIFO queue 26e intended to store data frames of the first data streams received at the first input port 15 to be transmitted in the communication network 4 via the second output port 18;
A FIFO queue 26f intended to store data frames of the second data streams received at the first input port 15 to be transmitted in the communication network 4 via the second output port 18;
A FIFO queue 26g intended to store data frames of the first data streams received at the second input port 16 to be transmitted in the communication network 4 via the second output port 18; and
A FIFO queue 26h intended to store data frames of the second data streams received at the second input port 16 to be transmitted in the communication network 4 via the second output port 18.

The electronic circuit 19 of each of the switches 9, 10, 11, 12 therefore comprises a memory 26 distributed according to the data streams (in this case first data streams and second data streams) passing through the communication network 4.

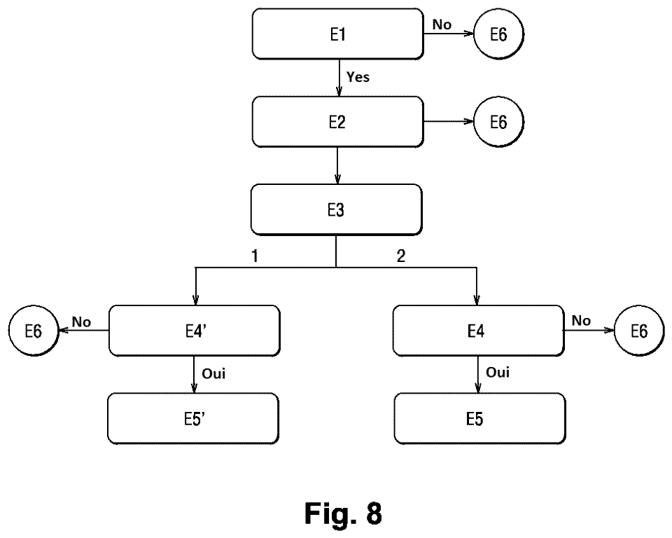

In reference to FIG. 8, when a data frame is received at one of the input ports 15, 16 of the switches 9, 10, 11, 12, the validity of said data frame is first checked (step E1). If the data frame is not valid, it is rejected (step E6). Next, a broadcast profile for the data frame is determined, i.e., the output port or ports (from among the output ports 17, 18) from which said data frame is to be transmitted (step E2). The step E2 is carried out by the correspondence unit 20 of the switches 9, 10, 11, 12 which includes the static table 20a. A data stream to which the data frame belongs is then determined (the priority of said data frame is thus determined) (step E3). The step E3 is also carried out in the correspondence unit 20 of the switches 9, 10, 11, 12. Once the data stream has been determined, the size of the data frame is checked (step E4 for the data frames of the first data streams and step E4′ for the data frames of the second data streams). If the data frame is valid, said data frame is stored in the memory 26 and, more specifically, in the appropriate FIFO queue or queues according to its broadcast profile (step E5 for the data frames of the first data streams and step E5′ for the data frames of the second data streams).

It is therefore provided that the electronic circuit 19 of each of the switches 9, 10, 11, 12 of communication network 4 can implement the steps described above.

The electronic circuit 19 of each of the switches 9, 10, 11, 12 of the communication network 4 is arranged so that the unit transit time of the data frames of the first data streams is substantially fixed. The unit transit time of the data frames is therefore predefined for each output port for each of the switches 9, 10, 11, 12 of the communication network 4. The data frames of the first data streams therefore have a jitter substantially equal to 0 ns. For example, the unit transit time of the data frames of the first data streams is equal to 10 ns or indeed to 100 ns.

The electronic circuit 19 of each of the switches 9, 10, 11, 12 of the communication network 4 is arranged so that the unit transit time of the second data frames of the second data streams has a variation less than a predefined variation threshold. The data frames of the second data streams therefore have a jitter which is not zero but which is, in this instance, limited.

The electronic circuit 19 of each of the switches 9, 10, 11, 12 is therefore arranged to perform a data frame prioritization function for each of the output ports 17, 18. The prioritization function is in this instance implemented in each of the control units 22a, 22b dedicated respectively to the output ports 17, 18.

For example, the prioritization function of the electronic circuit 19 is implemented by an FPGA.

The data frames of the first data streams are therefore systematically queued for a waiting period before being transmitted. This ensures that the transit time of each of the data frames of the first data streams is substantially fixed. Furthermore, the waiting period may be variable depending on the output port via which the data frame is transmitted.

When one of the output ports 17, 18 of the switches 9, 10, 11, 12 needs to both transmit a data frame of a first data stream and a data frame of a second data stream, the electronic circuit 19 is arranged so that the unit transit time of the data frame of the first data stream is strictly observed. The data frame of the second data stream is therefore queued until the data frame of the first data stream is transmitted. However, if the FIFO queues (for one of the output ports 17, 18) of the memory 26 dedicated to storing the data frames of the first data streams are empty, the data frame of the second data stream is transmitted.

Furthermore, if the unit transit time of a data frame of a first data stream is to be greater than a time required for the transmission of a data frame of a second data stream, said data frame of the second data stream is transmitted before said data frame of the first data stream. This allows maximum use of the output ports 17, 18 of the switches 9, 10, 11, 12.

It is also possible to assign a priority level between different data streams from among the first data streams. When one of the output ports 17, 18 of the switches 9, 10, 11, 12 needs to transmit data frames of first data streams having different priority levels, said data frames are transmitted in ascending order of priority.

According to the second embodiment of the invention, the overall transit time of the data frames passing through the communication network 4 is therefore constrained.

The communication network 4 according to the invention is particularly advantageous because each switch is arranged to control the overall transit time of a data frame. The transit time of the data frame is controlled either by measuring the overall transit time (first embodiment) or by constraining the transit time (second embodiment). The data frame is, in this instance, monitored on an overall basis. This ensures that no obsolete data frame is transmitted to the electronic processing units. Moreover, the overall monitoring of the data frames is carried out without being dependent on a particular protocol.

Furthermore, the communication network according to the invention ensures that the integrity of the data transmitted by the electronic processing units is maintained.

Furthermore, the communication network according to the invention does not require one or more additional data frames to be transmitted (in a staggered manner) in addition to the data frame comprising the payload data to be transmitted.

The communication network according to the invention functions with electronic processing units that are asynchronous. The communication network according to the invention therefore does not require synchronization or a global time reference.

The communication network according to the invention helps improve the integrity of the transit time and the transit path of the data frames.

The communication network according to the invention therefore helps improve the overall availability and effectiveness (optimisation of data frame transit) of the electronic architectures in which it is implemented.

Naturally, the invention is not limited to the described embodiments, but covers any variant that falls within the scope of the invention as defined by the claims.

The communication network according to the invention has in this instance been described as applied to an aircraft but it could be implemented in any electronic architecture comprising a plurality of electronic processing units that need to be connected to one another.

It is possible to freely combine the two embodiments of the invention and the variants disclosed above.

This description describes a communication network 4 comprising four switches 9, 10, 11, 12 for connecting four electronic processing units 5, 6, 7, 8 to one another, but the communication network could comprise a number P (where P>0) of switches for linking a number Q (where Q>0) of electronic processing units. Furthermore, the number P could be less than, equal to or indeed greater than the number Q.

In this instance, the switches 9, 10, 11, 12 of the communication network 4 comprise two input ports 15, 16 and two output ports 17, 18, but the switches could naturally comprise a number of input ports and a number de output ports other than two. The switches could comprise M input ports (M>0) and N output ports (N>0). Generally, the number of input ports M is equal to the number of output ports N, but that is not always the case. In reference to the first embodiment of the invention, it should be noted that, if the switches comprise M input ports and N output ports, the memory 21 of the switches comprises M FIFO queues for each of the N output ports. As a variant, the memory 21 of the switches comprises two FIFO queues for each of the N output ports, i.e., a priority FIFO queue and a non-priority FIFO queue. There could also be more than two priority levels and at least one FIFO queue for each priority level.

The additional functions of the electronic circuit 19 of the switches 9, 10, 11, 12 described in the embodiments are implemented by an FPGA, but it is perfectly possible to use a processor, a microcontroller, a DSP (digital signal processor) or an ASIC (application-specific integrated circuit).

Furthermore, the internal architecture of the switches 9, 10, 11, 12 described above is not limiting. The electronic circuit 19 is in this instance described as being a PCB, but the electronic circuit could also be made up of several different PCBs connected to one another.

In the first embodiment, it is also provided that a data frame comprises one or more delimiters for delimiting the data extensions relating to the switches through which the data frame has passed. This enables the tail switch or the recipient electronic processing unit to know the number of switches through which the data frame has passed. This makes it possible to know, at the receiver (End System), the number of switches through which the data frame has passed and the precise transit path of said data frame through the communication network (in particular by acquiring the identifier of each output port of each switch through which the data frame has passed).

The integrity data has been described in this instance as being an FCS error detection code calculated via a CRC algorithm to ensure that the data frames remain compliant with the IEEE 802.3 standard. However, any other type of integrity data that ensures that the data frames remain compliant with the IEEE 802.3 standard could be used. Furthermore, if another standard is used in the communication network, the integrity data could, for example, be a checksum or indeed any other error detection code used in the telecommunications field.

The invention is applicable to types of communication protocols other than those mentioned.

1. A communication network for connecting a plurality of electronic processing units to one another, the network comprising at least one switch which has at least one input port and one output port for connecting it to the electronic processing units and which is arranged to transmit a data frame of a data stream between at least two of the electronic processing units, the switch comprising at least one electronic circuit that is arranged to control a transit time of the data frame between the two electronic processing units.

2. The network according to claim 1, in which the switch comprises a plurality of input ports and a plurality of output ports, and in which the electronic circuit is arranged to:
determine a unit transit time of the data frame between the input port at which the data frame is received and the particular output port from which the data frame is transmitted; and
introduce, by concatenation, at the tail of the data frame, a data extension associated with the switch, the data extension comprising the determined unit transit time.

3. The network according to claim 2, comprising several switches connected to one another for transmitting the data frame between a head switch situated immediately downstream of the electronic processing unit transmitting the data frame and a tail switch situated immediately upstream of the electronic processing unit receiving the data frame, the electronic circuit of each switch being arranged to successively introduce the data extension at the tail of the data frame by concatenation.

4. The network according to claim 3, in which the electronic circuit of the tail switch is arranged to extract the data extension associated with each switch by deconcatenation, the electronic circuit of the tail switch is arranged to sum the unit transit times and calculate the overall transit time of the data frame.

5. The network according to claim 4, in which the electronic circuit of the tail switch is arranged to compare the overall transit time of the data frame to a predefined overall transit time threshold.

6. The network according to claim 4, in which the data extension associated with each switch respectively comprises an identifier of each switch, the electronic circuit of the tail switch is arranged to determine a transit path of the data frame between the head switch and the tail switch.

7. The network according to claim 4, in which the data extension associated with each switch respectively comprises an identifier of the particular output port of each switch from which the data frame is transmitted.

8. The network according to claim 3, in which the electronic processing unit receiving the data frame is arranged to extract the data extension associated with each switch by deconcatenation, and the electronic processing unit receiving the data frame is arranged to sum the unit transit times and calculate the overall transit time of the data frame.

9. The network according to claim 3, in which the electronic circuit of each switch is arranged to successively introduce a piece of integrity data relating to the data extension by concatenation.

10. The network according to claim 9, in which the integrity data is calculated at each switch.

11. The network according to claim 9, in which the integrity data is overall integrity data.

12. The network according to claim 2, in which the data frame comprises an additional field, all of the bits of which are at a predetermined logic level, one of the bits of the additional field being allocated to each of the switches and each switch being arranged to modify the bit of the additional field relating to said switch when the data frame passes through it.

13. The network according to claim 2, through which first data streams configured to have priority over second data streams pass and the electronic circuit comprises a memory in which there are defined a first FIFO queue dedicated to each output port of each switch for storing first data frames of the first data streams and a second FIFO queue dedicated to each output port of each switch for storing second data frames of the second data streams.

14. The network according to claim 13, in which the electronic circuit is arranged so that the unit transit time of the first data frames of the first data streams is substantially fixed.

15. The network according to claim 13, in which the electronic circuit is arranged so that the unit transit time of the second data frames of the second data streams has a variation less than a predefined variation threshold.

16. The network according to claim 13, in which priority levels are assigned to distinct data streams from among the first data streams and/or the second data streams, the electronic circuit is arranged so that the data frames of the distinct data streams are transmitted in ascending order of priority.

17. A switch arranged to implement the communication network according to claim 1.

18. An electronic architecture comprising a plurality of electronic processing units connected to one another by the communication network according to claim 1.

19. An aircraft comprising the electronic architecture according to claim 18.
